(19) United States
(12) Patent Application Publication
(10) Pub. No.: US 2016/0239930 A1
(43) Pub. Date: Aug. 18, 2016

(54) ImmigrationAnytime is an App in which a client may prepare legal petitions, namely immigration applications, via a computer interface such as a smart phone or tablet. It is a system that collects,validates data, and transfers them into all the necessary legal forms. The system is designed to perform these functions using an interface that is intuitive and designed to be secure and available at all times from the users smartphone or tablet without needing internet or cellular connection

(71) Applicant: Kimya Payami, Huntington Beach, CA (US)

(72) Inventor: Kimya Payami, Huntington Beach, CA (US)

(21) Appl. No.: 14/622,897

(22) Filed: Feb. 15, 2015

(51) Int. Cl. G06Q 50/18; G06F 17/22; G06F 3/0482; G06F 17/24; H04M 1/02; G06F 3/0485

(52) U.S. Cl. CPC G06Q 50/18; H04M 1/0202; G06F 3/0485; G06F 3/0482; G06F 17/243; G06F 17/2247; G06F 17/2205

(57) ABSTRACT

ImmigrationAnytime is an App in which a client may prepare legal petitions, namely immigration applications, via a computer interface such as a smart phone or tablet. It is a system that collects, validates data, and transfers them into all the necessary legal forms. The system is designed to perform these functions using an interface that is intuitive and designed to be secure and available at all times from the user's smartphone or tablet without needing internet or cellular connection.

ImmigrationAnytime is an App in which a client may prepare legal petitions, namely immigration applications, via a computer interface such as a smart phone or tablet. It is a system that collects, validates data, and transfers them into all the necessary legal forms. The system is designed to perform these functions using an interface that is intuitive and designed to be secure and available at all times from the user's smartphone or tablet without needing internet or cellular connection.

### SPECIFICATION

### Background

According to data obtained from the U.S. Department of Homeland Security, in 2013, the total number of nonimmigrants admitted into The United States was 61,052,260 (Nonimmigrant admissions to the United States: 2013). The total number of people naturalized in The United States in 2013 was 779,929 (U.S. Naturalizations: 2013). The total number of people who became lawful permanent residents of The United States in 2013 was 990,553 (U.S. Lawful Permanent Residents: 2013). Lastly, the total number of people admitted to The United States as refugees in 2013 was 70,000 (Refugees and Asylees: 2013). With president Obama's 2014 executive action, 4 million work visas could be potentially issued.

Every one of the cases references above involves proper completion of one or more government forms. “proper” is the keyword here. If petitions are not completed according to the guidelines and if they are not submitted with the proper filing fee or supporting documentation then there is a good chance that the petition is denied. Petition management systems that are currently available in the market are built for the expert members of the legal community.

Petition management systems that are currently available in the market are designed to run entirely on the internet or rely heavily on the internet for user access, user interaction and data storage, and because of that accessing these systems require internet connection.

Petition management systems that are currently available in the market do not fit the needs of many people. Most people either do not have ongoing access to the internet because they keep going on/off the grid, they do not trust saving their data onto external data storage facilities, or their data plan does not allow them constant access to the internet.

With the increased popularity of smart phones and tablet, most people like to read, play and do work at all times using these devices with or without internet or WiFi connections. Petition management systems that are currently available in the market do not accommodate this.

Legal petitions, in most cases, are accompanied with one or more supporting documents. Petition management systems that are currently available in the market facilitate this requirement via time consuming and tedious steps that involve scanning, saving and uploading of documents.

Petition management systems that are currently available in the market do not support the more secured biometrics access mechanisms such as, for example, TouchID. There is a need for a petition management system that addresses the above, and other problems.

### SUMMARY OF THE INVENTION

An object of the invention is to provide a system that collects, validates data, and transfers them into all the necessary legal forms. The system is designed to perform these functions using a human interface that is easy and intuitive. Further, the system is designed to be secure and available from user's smartphone or tablet at all times without the need for an internet or cellular connection.

The system also provides a secure attorney-client communication channel allowing an attorney to review client data and offer consultation.

To that end, in an embodiment, the invention provides an App in which a client may prepare legal petitions, namely immigration applications, via a computer interface without contacting an attorney, optionally transmit petition to an attorney for review, print, sign and file application.

In an embodiment, the invention provides a system for creation of accurate and acceptable legal petitions by attorneys, applicants and petitioners that can be submitted to the appropriate governmental authority, such as the U.S. Citizenship and Immigration Services and U.S. Department of State.

In an embodiment, the invention provides the client with hard copies of completed forms which require signature; and with a list of supporting documents to be packaged with the forms prior to submission.

In an embodiment, the invention utilizes the Camera and Photo Library of client device to capture and attach supporting documents.

In an embodiment, the invention completes all required forms for a given petition. As well, the invention automatically generates exhibits to hold additional information provided by user.

In an embodiment, the invention is fully downloaded to client device once, and every time there is an update. Once on client device, the invention runs in standalone mode without the need for further access to the internet until client is ready to print the petition.

In an embodiment, the invention operates in environments such as, for example, airplanes and remote areas where there is little to no internet access.

In an embodiment, the invention supports a diverse community of users by operating in many languages such as, for example, English, Spanish, Korean, Vietnamese, Chinese, Farsi, French and German.

### DRAWINGS

### Brief Description of the Drawings

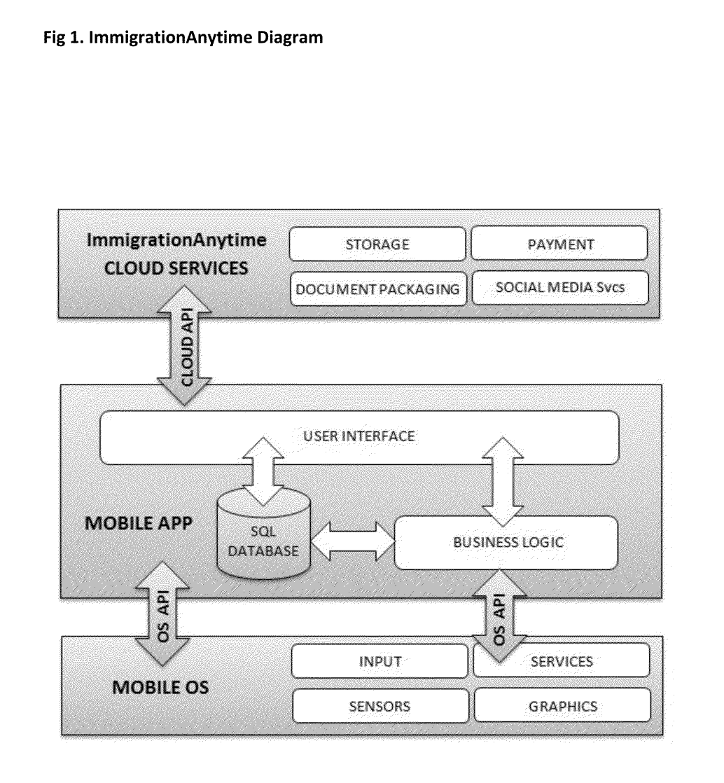

FIG. 1. illustrates a system with which the invention can be practiced.

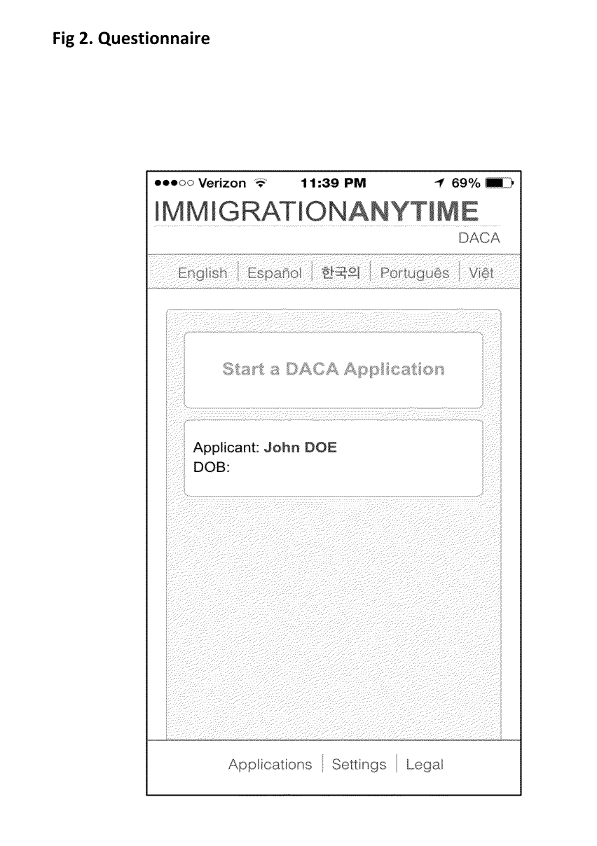

FIG. 2 illustrates the interface that allows user to open an existing petition or create a new one.

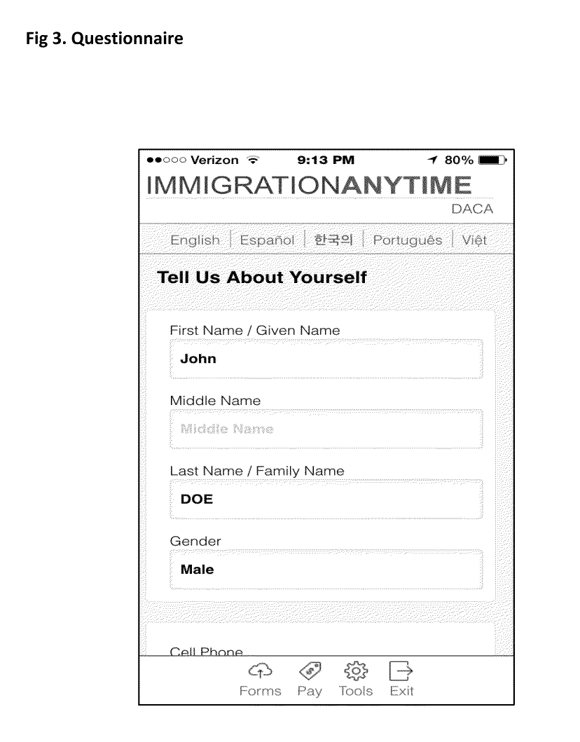

FIG. 3 illustrates a questionnaire interface useful for a client to input data into the system described herein.

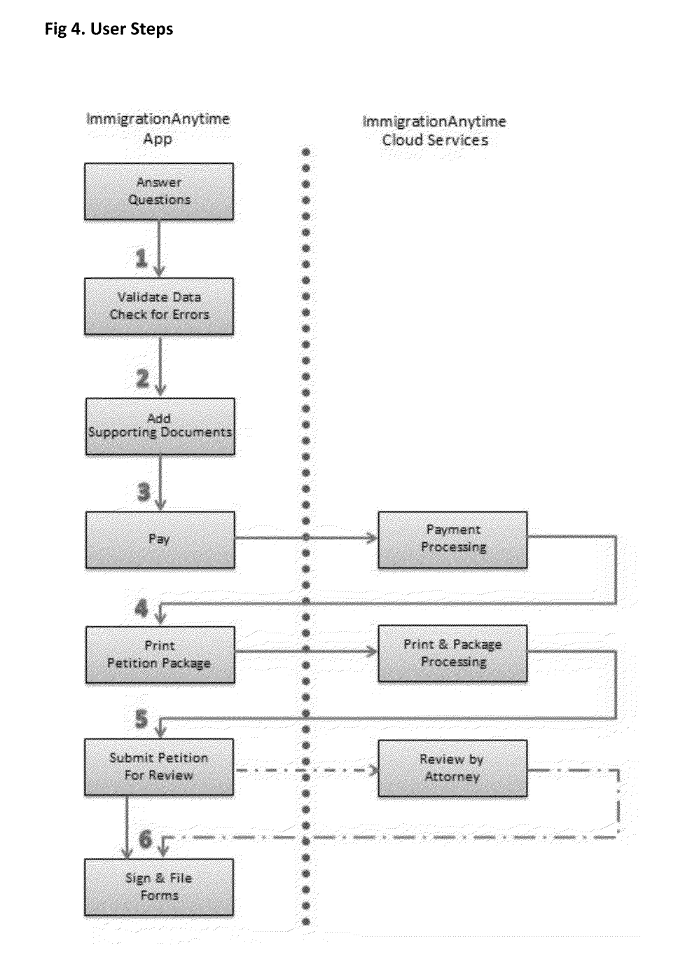

FIG. 4 illustrates steps a client must take to prepare and file a petition.

What is claimed is:

1. A computerized system for creating legal Petitions comprising: at least one client application, wherein,
(i) the client application downloads and installs into user's smartphone or tablet from App Store or website,
(ii) the client application is stored locally,
(iii) access to client application is protected by a password or Biometric technology
(iv) a user is authenticated by the client application using Social Media Services,
(v) a user engages with the client application without any need for internet or WiFi connection,
(vi) a user creates legal, namely immigration, petitions in the language of user's choice,
(vii) the user account information is securely stored on user's own device,
(viii) a user creates legal petitions via the client application, the one or more legal petitions for which one engages an attorney,
(ix) the user petition information for each respective user being accessible by the respective user and not by other users,
(x) petition information is automatically saved as user jumps from one question to the next,
(xi) legal petitions created by the user are stored locally,
(xii) legal petitions created by the user are backed up automatically,
(xiii) the client application is an advanced single-page application (SPA), utilizing HTML5, JavaScript and CSS,
(xiv) the client application is designed to exchange information with third-party systems via IA Services,
(xv) the client application is designed to exchange information with government e-file systems.
(xvi) the client application includes:
(a) a questionnaire interface that is displayed at the client and via which the user submits information relevant to the legal petition;
(b) a scrollable interface that is displayed at the client and via which said user chooses a petition to open to work with;
(c) a menu interface labeled “Pay” that is displayed at the client;
(d) a menu interface labeled “Forms” that is displayed at the client;
(e) a menu interface labeled “Review” that is displayed at the client;
(f) a menu interface labeled “Documents” that is displayed at the client;
(g) a menu interface labeled “Settings” that is displayed at the client;
(h) a menu interface labeled “Legal” that is displayed at the client; and
(i) a menu interface labeled “Applications” that is displayed at the client.

2. The system of claim 1, wherein said client application downloads and installs into user's smartphone or tablet such as, for example, iPhone, iPad, Android phone, and Android tablet.

3. The system of claim 1, wherein said client application downloads and installs into client computer such as, for example, PC, and Mac, and runs inside a web browser.

4. The system of claim 1, wherein said client application downloads and installs into user's smartphone or tablet's own device storage.

5. The system of claim 2, wherein downloaded files are Apps native to user's device.

6. The system of claim 5, wherein native Apps carry on file extensions such as, for example, .ipa, .apk, .xap and .html.

7. The system of claim 1, wherein user is granted access to the client application using Biometric technology.

8. The system of claim 7, wherein Biometric is technology such as, for example, iOS TouchID.

9. The system of claim 7, wherein in the absence of an acceptable Biometric technology, a password is accepted.

10. The system of claim 1, wherein in user authentication is managed by Social Media Services such as, for example, Facebook, Google+, Yahoo, Windows or Twitter.

11. The system of claim 1, wherein a user's account information is securely stored on user's own device using existing security apparatuses such as, for example, Keychain services offered by iOS and Android.

12. The system of claim 11, wherein said account information is comprised of a many pieces of information such as, for example, username, password, payment information.

13. The system of claim 1, wherein the client application is stored locally and available at all times.

14. The system of claim 1, wherein a user creates legal petitions such as, for example, DACA, DAPA, immigration and citizenship applications.

15. The system of claim 1, wherein the user is a petitioner, requestor, applicant, attorney or an accredited representative.

16. The system of claim 1, wherein said questionnaire is an advanced single-page application (SPA), comprising of a single interactive, dynamic, and responsive HTML5 page.

17. The system of claim 16, wherein said HTML page comprises of a series of question/answer sections that are dynamically loaded based on user interaction and answers provided on other parts of the questionnaire interface.

18. The system of claim 1, wherein the “Pay” menu offers user the option to pay for the petition, to restore purchases on another device and to generate a listing of all payments.

19. The system of claim 18, wherein payment activities are managed by an online payment service.

20. The system of claim 19, wherein online payment service includes Apple Store, Google Play, Microsoft Store and Paypal.

21. The system of claim 1, wherein the “Forms” menu offers user the option to Print and email the petition package.

22. The system of claim 21, wherein petition package refers to a collection of all completion legal forms and all the supporting documents.

23. The system of claim 1, wherein the “Forms” menu offers user the option to backup petition package to IA server.

24. The system of claim 23, wherein IA server is a cloud storage facility.

25. The system of claim 1, wherein the “Forms” menu offers user the option to share petition package via email with a recipient of user's choice.

26. The system of claim 1, wherein the “Review” menu offers user the option to check for errors and to ask for attorney review of the petition package.

27. The system of claim 26, wherein checking for errors covers, for example, formatting, validation and business logic errors.

28. The system of claim 26, wherein attorney review offers services of an attorney to review the package and provide consultation.

29. The system of claim 1, wherein the “Documents” menu offers user a list of supporting documents and allows user to take photos, or use existing photos, of supporting documents and attach them to the petition.

30. The system of claim 29, wherein client application asks for access to camera and photo library on user's device.

31. The system of claim 1, wherein the “Settings” menu offers user the option to change default settings of the system such as, for example, authentication options.

32. The system of claim 1, wherein the “Legal” menu advises users of Terms & Conditions, Privacy and Security of the said client application.

33. The system of claim 1, wherein the “Applications” menu offers users the option to securely download petition packages from the IA server.

34. The system of claim 33, wherein said secure download utilizes Secured Socket Layer transport layer as well as token-based authentication.

35. The system of claim 1, wherein questions are presented to the user in language of user's choice such as, for example, English, Spanish, Korean, Chinese, Filipino, Portuguese, Farsi, German, French, and Vietnamese.

36. The system of claim 1, wherein payment must be paid before a petition is allowed to be printed, emailed, reviewed or exported.

37. The system of claim 1, wherein immigration petition includes immigrant, non-immigrant, citizenship, DACA and DAPA applications.

38. The system of claim 1, wherein storage of data on device is facilitated by a SQL database local to said device.

39. The system of claim 1, wherein back-up of petition data is automatically managed by services such as, for example, iCloud.

40. The system of claim 1, wherein the client application can integrate with third-party systems such as, for example, case management systems, document management systems, and matter management systems.

41. The system of claim 1, wherein the client application can exchange data with E-File systems available from government agencies such as, for example, U.S. Department of State, Department of Homeland Security, and USCIS.
